(19) United States
(12) Patent Application Publication
(10) Pub. No.: US 2017/0045073 A1
(43) Pub. Date: Feb. 16, 2017

(54) EZ fastener series

(71) Applicant: Jijun Liu, Sacramento, CA (US)

(72) Inventor: Jijun Liu, Sacramento, CA (US)

(21) Appl. No.: 14/756,186

(22) Filed: Aug. 13, 2015

(51) Int. Cl. F16B 23/00; F16B 35/04

(52) U.S. Cl. CPC F16B 23/0007; F16B 35/041

(57) ABSTRACT

The novel EZ fastener series is disclosed that a newborn round, square and triangle fasteners would make your next job from uncertain to very positive. The novel EZ fasteners comprise two parts of a male and a female. There are some parallel threads on the male; From the side, the threads look like jagged lines or saw teeth. There are a few movable teeth inside of the female forming a round, square and triangle hole in the center, and the teeth come with opposite saw teeth than the ones on the male. When a male goes into the hole of the female, the movable teeth inside of female will do open and close movement as a locking mechanism, the opposite saw teeth on both part will be griped and locked each other, the male can only go in not out.

### CROSS-REFERENCE TO RELATED APPLICATIONS

(Not Applicable)

### STATEMENT REGARDING FEDERALLY SPONSORED RESEARCH OR DEVELOPMENT

(not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

Fasteners are essential parts in our life. As we know, to build a house will need hundreds and thousands nails and screws; our every day vehicles need a lot of fasteners to put hundreds pieces of parts together. Nowadays the fasteners are not only used in industrial field, but also broadly used in residential area too.

In order to fasten two objects together, people usually chose screws or nails to complete their job. Normally screws are used with hard or thick materials like metal, wood or plastic. We also can use rivets to fasten objects, but rivets are used only with thin metal, and a special tool is required to finish the work.

Some times we need to connect two or more objects together without using screws or nails even glue; some times there is no enough room for screwing; some times the materials we will be put together are not allowed using traditional way to complete. Think about if these were the case, what would we use to fulfill the job?

The novel EZ fastener series solving the above problems are therefore desired and disclosed.

### BRIEF SUMMARY OF THE INVENTION

One exemplary embodiment of the disclosed subject matter is a novel EZ fastener series comprising round, square and triangle three different styles. The first one of the series is the round style fastener comprising a male with round body shape, and a female as a round cap with a round hole in the center. The second one of the series is the square style fastener comprising a male with square body shape, and a female cap in round shape with a square hole in the center. The third one of the series is the triangle style fastener comprising a male with the body in triangle shape, and a round female cap with a triangle hole in the center. There are some parallel lines as saw teeth looking on the male series, and some movable teeth inside of female series forming different shape of the holes at the center. When a male goes into the female, the saw teeth on the male will be griped by the teeth on the female because they have opposite jagged lines on their teeth, all the movable teeth inside of the females forming a hole as a locking mechanism comprising threads on their teeth, the male part can only go in not out. In order to fasten objects, just put them in between male and female, and push both parts until the objects fastened together. The novel EZ fastener series could work with any materials because they work as rivets fastening objects in between them, however there is no a special tool needed; instead, using users hands to finish the fastening. In addition, the novel EZ fastener series come with nice finish on their both side, and they would be broadly used in industrial field and our everyday life, people would get unlimited benefit from them.

### BRIEF DESCRIPTION OF THE SEVERAL VIEWS OF THE DRAWING

The following illustrated drawings are some non-limiting exemplary embodiments of the disclosed subject matter. Identical of similar structure, elements, or parts that appear in one or more drawings are generally labeled with the same reference numeral, optionally with an additional letter or letters to distinguish between similar objects or variants of objects, and may not be repeatedly labeled or described. Dimensions of components and features shown in the figures are chosen for convenience or clarity of presentation. For convenience or clarity, some elements or structures are not shown or shown only partially and/or with different perspective or from different point of views.

FIG. 1 is a side view of a novel EZ fastener with a male and a female showing the two parts are griped together by their opposite saw teeth as a locking mechanism.

FIG. 2 is a perspective view of a round male part of the novel EZ fastener series.

FIG. 2A is a top view of a round female part with four movable teeth in the center forming a round hole.

FIG. 2B is a side view of a round female part showing an arc shape with some thickness.

FIG. 2C is a section view of a round female with four movable teeth inside showing only two movable teeth with small space around them.

FIG. 3 is a perspective view of a square male part of the novel EZ fastener series.

FIG. 3A is a top view of a square female with four movable teeth in the center forming a square hole.

FIG. 3B is a section view of a square female showing three movable teeth only inside of it.

FIG. 4 is a perspective view of a triangle male of the novel EZ fastener series.

FIG. 4A is a top view of a triangle female with three movable teeth in the center forming a triangle hole.

FIG. 4B is a section view of a triangle female showing its movable teeth with space around them in side of it.

FIG. 5 is a side view of objects to be fastened by a novel EZ fastener.

### DETAILED DESCRIPTION OF THE INVENTION

As we know conventional screws, nails and rivets are made for fastening either hard or thick materials. In a practical world, we sometimes need to put thin objects together like paper; or put soft objects together like cloth; or thin and soft objects together like plastic; or thin and thick objects together like plastic and wood board combined; or soft and hard objects together like cloth and wood combined; or anything need to be connected together without using traditional way. Then the disclosed novel EZ fasteners would solve above problems.

The potential benefits of the disclosed subject matter include a novel fastener series that would fasten and connect any type of materials together without worry about possibilities. Additional benefits also include hands operating the fasteners without using a special tool as well as fast and easy fastening in seconds.

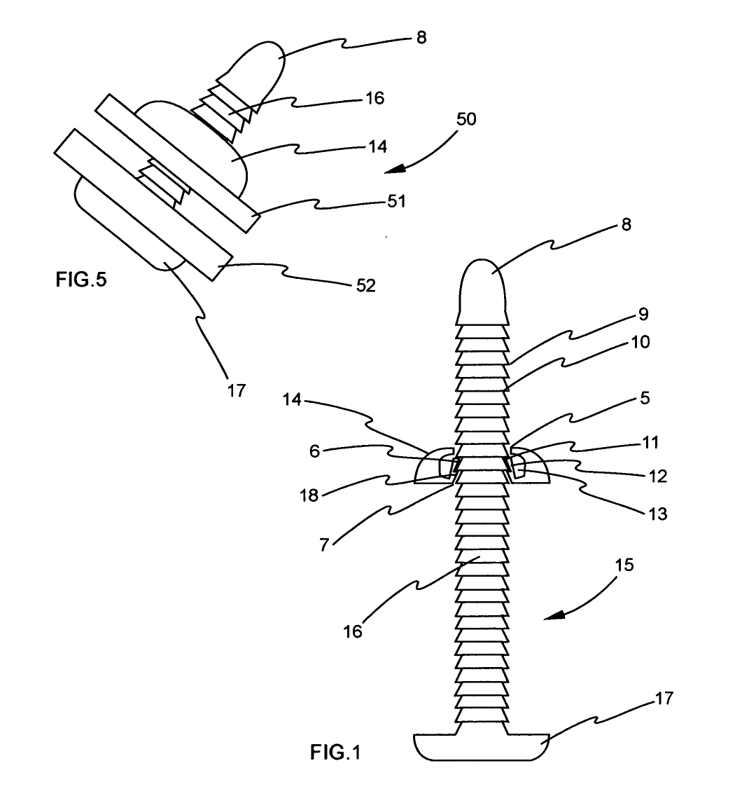

FIG. 1 is a side view of a novel EZ fastener series 15 according to an embodiment of the inventions disclosed herein, illustrating a male part 15 and female 14 are griped together by their opposite saw teeth 9, 10, 12 as a locking mechanism fastening objects between them.

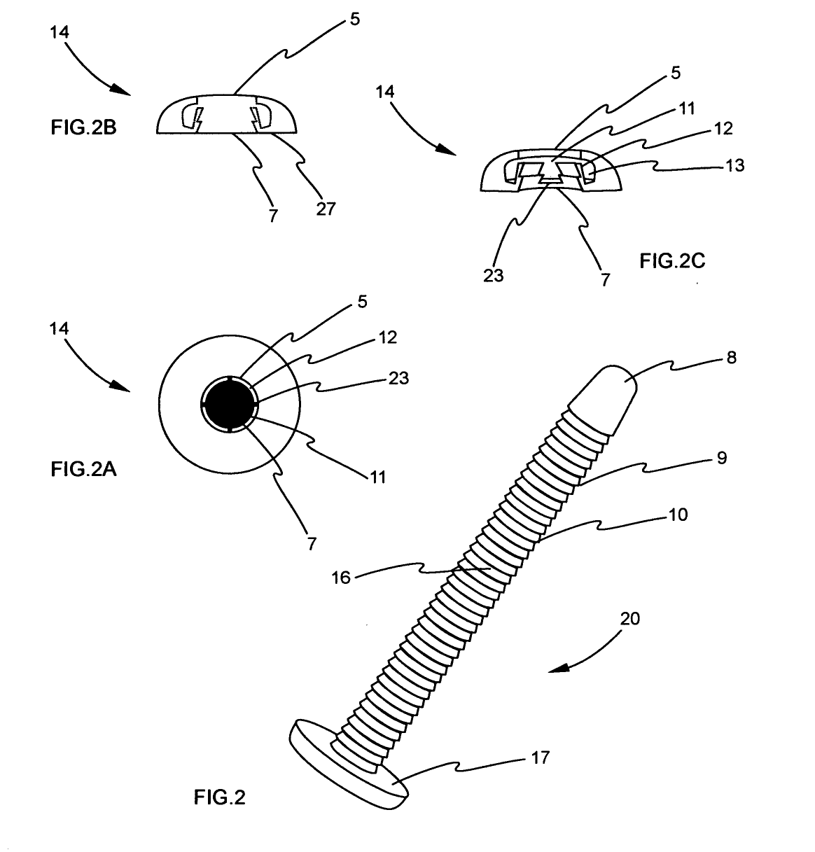

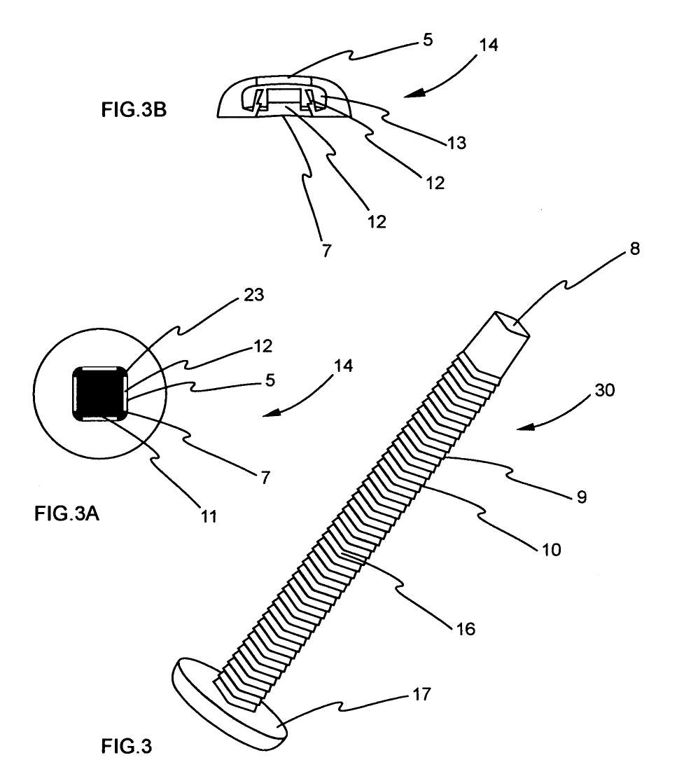

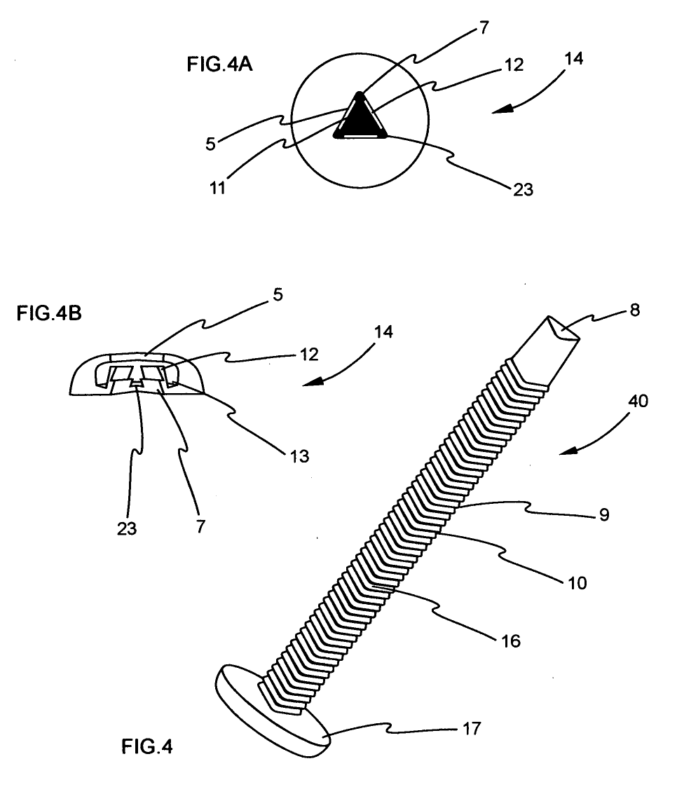

The male part 15, 20, 30, 40 look like a screw but it does not work like screw, even there are some threads on their body 15, 20, 30, 40 they are parallel threads 9,10 as seen in FIG. 1, Basically these lines are gradually changed circles connected each other 9, 10, from the side, the edge of the male body 16 looks like jagged lines, the size of its head 8 is little bit smaller than the bottom 7 and top 11,5 holes of the female. From the top, the female part 14 is round looking as seen in FIGS. 2A, 3A, 4A with a hole 11 in the center. From the side, a female looks like an arc form with some thickness as seen in FIGS. 1, 2B, 2C, 3B, 4B, Inside of the female 2A, 2B, 2C, 3A, 3B, 4A, 4B there are a few movable teeth 12 forming a hole 11 in the center of the females (Caps) 14, an around, a triangle and a square holes as seen in FIGS. 2A, 3A, 4A there are some space 13, 23 between and around the movable teeth as seen in FIGS. 1, 2A, 2C, 3A, 3B, 4A, 4B all males 15, 20, 30, 40 come with jagged lines or saw teeth on them, and they all come with a round cap 17, the male body 16 can be short or long depends on the size of the objects to be fastened. There are two saw teeth 6, 18 on each movable tooth 12, the two saw teeth are also two threads on the teeth 12, look like opposite jagged lines 6, 18 with the saw teeth on male body 16, when the male 20, 30, 40 into the female 2A, 3A, 4A, the head 8 of the male will go through the bottom hole 7 of the female, then push to open a smaller size hole 11, the movable teeth 12 will do a movement of open and close, their opposite saw teeth 9, 6, 18 will be griped together, continually pushing the male through the hole 5 of the female until the objects 51, 52 to be fastened as seen in FIG. 5

To fasten two objects 50, just put right size male 20, 30, 40 through the holes on objects which will be fastened, let the male 20, 30, 40, into the female 14, and press two parts together with users fingers and the male would be griped by movable teeth inside of the female, the male can only go in not out. By pushing the two parts until the objects 51, 52 to be fastened together. Finally, to cut extra part of the male with a cutter would get a nice finish. The novel EZ fastener series would be made of plastic and metal including aluminum, copper and stain less steel.

The invention claimed is:

1. The novel EZ fastener series comprising the round style fastener, the square style fastener and the triangle style fastener. The round style fastener comprising a male with round body, and a female with a round hole in the center; the square style fastener comprising a male with square body, and a female with a square hole in the center; the triangle style fastener comprising a male with triangle body, and a female with a triangle hole in the center. Novel EZ fastener series would be made of plastic, aluminum, copper and stain less steel.

2. The fastener of claim 1, the body of round style male is in round shape with parallel saw teeth threads on it.

3. The fastener of claim 1, the round style female comes with four movable teeth inside of it forming a round hole in the center, there are some space between and around the movable teeth.

4. The fastener of claim 1, the body of square style male is in square shape with parallel saw teeth threads on it.

5. The fastener of claim 1, the square style female comes with four movable teeth inside of it forming a square hole in the center, there are some space between and around the movable teeth.

6. The fastener of claim1, the body of triangle style male is in triangle shape with parallel saw teeth threads on it.

7. The fastener of claim 1, the triangle female comes with three movable teeth inside of it forming a triangle hole in the center, there are some space between and around the movable teeth.
